(19) United States
(12) Patent Application Publication
(10) Pub. No.: US 2009/0241127 A1
(43) Pub. Date: Sep. 24, 2009

(54) METHOD AND SYSTEM FOR PROVIDING ACCESS TO ACTIVE OBJECTS

(75) Inventor: Steffen Reymann, Redhill (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/721,172

(22) PCT Filed: Dec. 5, 2005
(86) PCT No.: PCT/IB05/54060

§ 371 Date: Jun. 8, 2007

(30) Foreign Application Priority Data
Dec. 8, 2004 (GB) 0426884.3

(51) Int. Cl. G06F 9/46

(52) U.S. Cl. 719/319; 718/102

(57) ABSTRACT

A method and system is provided for allowing a Java™ application to use active objects on the Symbian™ platform through the Java™ Native Interface (JNI). An active scheduler is started under Symbian™ and transferred into a separate thread after the first call to it has been made. Although the scheduler still exhibits blocking behaviour on restart, since it is executing in a separate thread, control can return to the calling Java™ application to permit the use of further active objects.

### OBJECTS

This invention relates to providing access to active objects between computing platforms, particularly but not exclusively to a method of providing a Java™ application with access to active objects in a Symbian™ operating system environment via the Java™ Native Interface (JNI), in a way that allows control to return to the calling Java™ application.

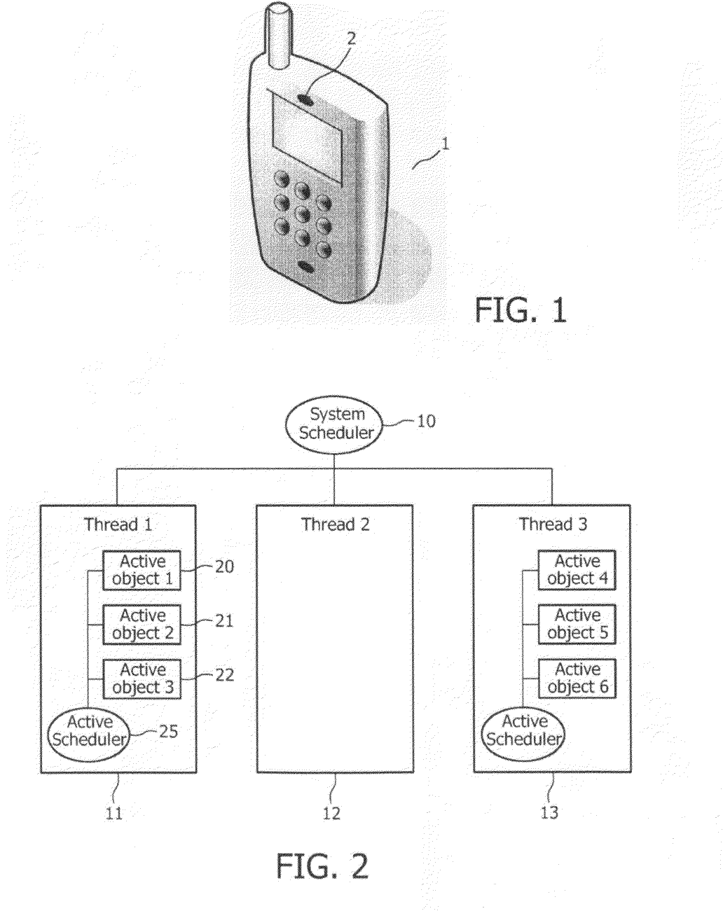

Symbian™ is the global industry standard OS (operating system) for smartphones. An example smartphone 1 is shown schematically in FIG. 1. A smartphone is a mobile telephone with advanced functionality, typically supporting e-mail and advanced browsing functionality along with the usual communication functionality. It may also include a camera 2.

The Symbian™ OS is largely written in C++, an object oriented computer language. Object oriented languages generally provide some means of multi-tasking. For example, the Java™ language, another well-known object-oriented language, provides for multi-tasking primarily through multi-threading, which allows execution of concurrent tasks in a plurality of separate threads.

The Symbian™ OS provides for preemptive multi-threading, so that it can run multiple applications and servers concurrently. Within a thread, active objects are used to provide non-preemptive multi-tasking, which makes multi-threaded programming unnecessary for most applications and servers. A large number of Symbian's™ classes derive from the active object base class CActive. An active object may be defined as an object that runs in its own thread of control. In the Symbian™ OS, an active object is any object that is derived from the base class CActive.

The relationship between threads and active objects in the Symbian™ OS is shown schematically in FIG. 2. A system scheduler 10 provides for preemptive multi-threading between a plurality of threads 11, 12, 13. Preemptive multi-threading means that each thread is given a fixed slice of CPU time, after which it is suspended so that the next thread can run. By switching between threads sufficiently frequently, the illusion of continuous thread execution is created.

In contrast, within a thread 11, there may be a plurality of active objects 20, 21, 22. Each thread may have an active scheduler 25 for scheduling CPU time between the active objects. The active scheduler 25 uses a non-preemptive approach, meaning that an active object that is executing is not suspended, but allowed to complete its task and return control to the active scheduler.

The Symbian™ OS discourages the multi-threaded approach in favour of the active object approach. Under this OS, it is easier to write a program enabling a system of co-operating active objects than it is to write a program enabling a system of co-operating threads. Communication between threads is slower and more difficult than between active objects and the run-time cost of an active object is significantly less than that of a thread. Furthermore, creating and destroying active objects is much more efficient in terms of processor operating load than creating and destroying threads. Typically, therefore, Symbian™ applications use a process containing a single thread, with multiple active objects within the thread.

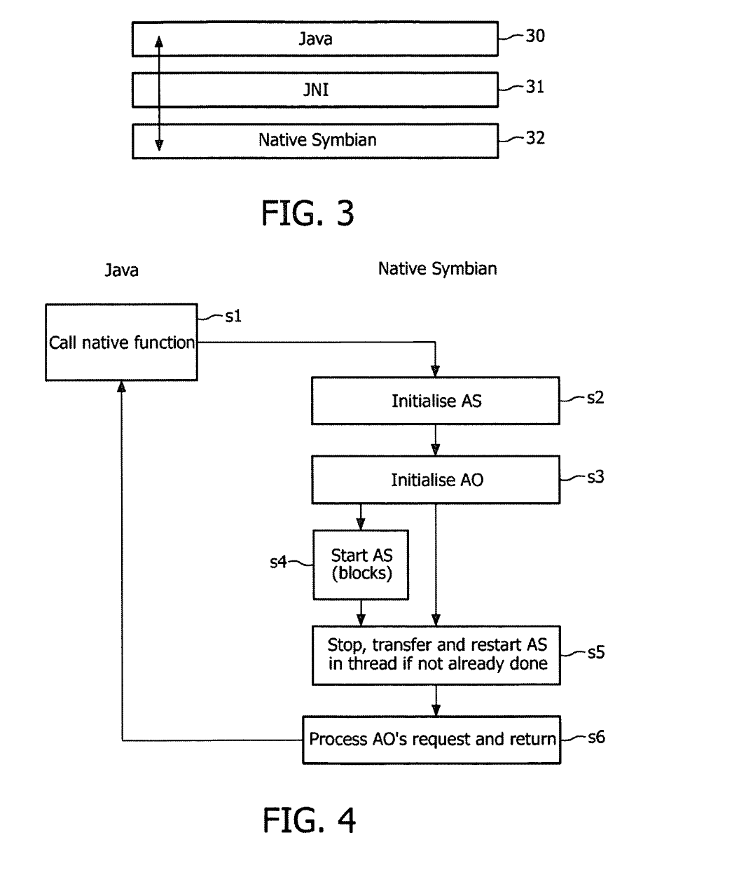

Due to its portability between computing platforms, the Java™ language has become very widespread and popular, in particular for GUI (graphical user interface) development. Java™ is therefore commonly used for developing applications for the Symbian™ platform, which provides a Java™ implementation. However, to maintain its portability, Java™ is not designed to use lower level device functions directly, for example, to access device drivers for a camera, or Bluetooth or infra-red devices. The usual way for Java™ to access such native functions is via the Java™ Native Interface (JNI) 31, which provides a ‘translation layer’ between the Java™ environment 30 and the native Symbian™ environment 32, as schematically illustrated in FIG. 3.

However, in its Symbian™ implementation, the JNI 31 is not designed to interact with active objects.

Considering the technical advantages deriving from using active objects in place of threads, it would be desirable to allow Java™ programs access to active objects in the Symbian™ OS.

Embodiments of the invention provide a mechanism for allowing access to active objects from Java™ via the JNI. More generally, the invention is applicable to any environment where applications on one computing platform do not have direct access to active objects on a second computing platform.

According to the invention there is provided a method of providing access from a first computing platform to active objects on a second computing platform, the method comprising receiving a function call from an application on the first computing platform, in response to the function call, starting an active scheduler in a first thread of control on the second computing platform, the active scheduler being arranged to service requests from the active objects, creating a second thread of control on the second computing platform and transferring the active scheduler into the second thread to enable control to return to the calling application.

The active scheduler may be transferred in response to a request from an active object, or from a timer object started for the purpose of transferring the active scheduler.

The method may include the step of determining whether the request from the active object is the first request in a plurality of requests, and only transferring the active scheduler into a separate thread if that is the case. Determining whether the request is the first request may be done by using a state machine.

According to the invention, there is further provided a system for providing access from a first computing platform to active objects on a second computing platform, the system comprising means for receiving a function call from an application on the first computing platform, means responsive to the function call, for starting an active scheduler in a first thread of control on the second computing platform, the active scheduler being arranged to service requests from the active objects, means for creating a second thread of control on the second computing platform and means for transferring the active scheduler into the second thread to enable control to return to the calling application.

The transferring means may comprise means for stopping the active scheduler in the first thread and means for restarting the scheduler in the second thread.

According to the invention, there is still further provided a computer program for providing access from a first computing platform to active objects on a second computing platform which, when executed on a computer, is configured to receive a function call from an application on a first computing platform, in response to the function call, start an active scheduler in a first thread of control on a second computing platform, the active scheduler being arranged to service requests from the active objects, create a second thread of control on the second computing platform and transfer the active scheduler into the second thread to enable control to return to the calling application.

Embodiments of the invention will now be described, by way of example, with reference to the accompanying drawings, in which:

FIG. 1 schematically illustrates a smartphone in which examples of the invention can be implemented;

FIG. 2 schematically illustrates how a Java™ application communicates with the operating system of the smartphone shown in FIG. 1;

FIG. 3 illustrates the relationship between active objects and threads in the Symbian™ OS environment;

FIG. 4 is a flow diagram illustrating the principles of the invention; and

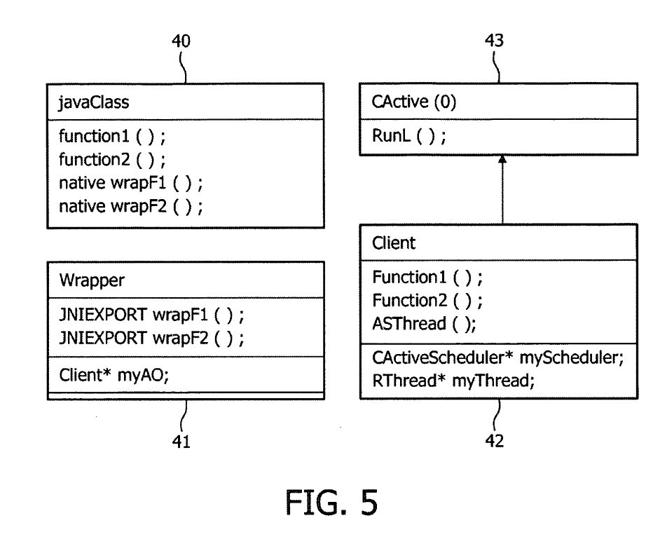

FIG. 5 is a structure diagram illustrating the structure of a program for implementing the invention.

As mentioned above, in the Symbian™ OS, active objects (AOs) require an active scheduler (AS) running that can serve their requests. Nearly all threads use an active scheduler. If an active scheduler is present, active objects may be added to it and removed from it as required.

Since there is no active scheduler present under JNI™, an active scheduler needs to be started manually. Although this functionality is provided in the CActiveScheduler class of the Symbian™ OS, the call to the Start( ) function defined within this class for starting the scheduler, blocks. This means that the call to the native (Symbian™ OS) function will not return to the Java™ caller and no further processing can be done. With the mechanism described below, this behaviour is avoided. Instead, the active scheduler is started in a way that control can be returned to the Java™ application and further requests to and from active objects can be made.

Put simply, when a first request to an active scheduler is made, the active scheduler is transferred into a separate thread. The initiation can either be from the active object that is in use or from a timer object started only for that purpose. The procedure for effecting this scheme is shown in FIG. 4.

Referring to FIG. 4, a Java™ program calls a native function in the Symbian™ OS (step s1). The native function initialises the active scheduler 25 in the native Symbian™ (step s2) as well as an active object 20 (step s3). The active scheduler is started (step s4) and blocks, so preventing return to the Java™ program by this route. In parallel, the active object calls the processing method of the active scheduler (step s5). The processing method stops the active scheduler, transfers it into a separate thread and restarts it, if this has not already been done. Then, the active object's request is processed (step s6), before the procedure returns to the Java™ program.

FIG. 5 illustrates the structure of a program according to the invention for implementing the process shown in FIG. 4. The structure comprises a Java program 40, a Wrapper class 41, which handles the JNI, and a Client class 42 derived from the base active object class CActive 43. In the description below, it will be understood by the skilled person that certain base classes and methods are defined as part of the Symbian™ OS. These classes include the CActive, CActiveScheduler and RThread classes. Methods defined by these classes include but are not limited to the SetActive( ) method and the virtual RunL( ) method.

The Java™ program comprises a class 40 referred to herein as javaClass which declares and calls first and second Java™ functions function1( ) and function(2), and declares and calls first and second native functions wrapF1( ) and wrapF2( ).

The Wrapper class 41 includes the program code for the native functions wrapF1( ) and wrapF2( ) written in C++ for creating the active objects.

The Client class 42 is derived from the base active object class CActive in the Symbian™ OS and implements the control of the active scheduler.

To illustrate the mechanism of the invention, it is assumed here that a function named function1( ) is called by the Java application 40, and that this contains the first call to a native function in the Symbian™ OS. All code fragments needed to implement this embodiment, as well as the flow, now follow.

[javaClass]
function1( ) {

(...)
wrapF1( );

}

The [javaClass] class 40 calls the Java™ function function1( ), which in turn calls the native function wrapF1( ), and control passes to the Symbian™ OS 22.

[Wrapper]
wrapF1( ) {

(...)
myAO = new(ELeave)Client;
myAO−>Function1( );
return;

}

The native function wrapF1( ) is contained in the Wrapper class 41. The code ‘myAO=new(ELeave)Client’ creates an active object called myAO, of the Client class 42. The code ‘myAO->Function1( )’ calls the function Function1( ) defined in the Client class 42, which is the native function that corresponds to the Java™ function function( ). The code ‘return’ hands control back to Java™ 40.

The Client class 42 is set out below:

[Client]
Client::Client( ) : CActive(0) {

myScheduler = new(ELeave)CActiveScheduler;
CActiveScheduler::Install(myScheduler);
CActiveScheduler::Add(this);
myThread = new RThread( );
return;

}
Client::Function1( ) {

(...)
SetActive( );
return;

}
Client::RunL( ){

(...Code to implement first time decision)
//if first time this function is called:
myScheduler−>Stop( );
myThread−>Create(..., (TInt (*)(TAny *))ASThread,...,this,...);
myThread−>Resume( );
(...)
return;

}
TInt Client::ASThread(TAny* ptr) {
((Client*)ptr)−>myScheduler−>Replace(myScheduler);
myScheduler−>Start( );
}

The Client class is declared in the ‘Client::Client( ):CActive(0)’ code fragment, which also indicates that the Client class is derived from the CActive base class of the Symbian™ OS, so that objects of the Client class will be active objects. The code fragment also signifies that active objects will be constructed with a priority set to zero.

The code “myScheduler=new(ELeave)CActiveScheduler” creates an active scheduler object called myScheduler of the CActiveScheduler class in the Symbian™ OS. This is installed as the active scheduler by the code ‘CActiveScheduler::Install(myScheduler)’.

The code ‘CActiveScheduler::Add(this)’ adds the active object myAO to the list of objects maintained by the active scheduler 25.

The code ‘myThread=new RThread( )’ constructs a thread object called myThread of the Symbian™ OS RThread class.

The Client class 42 includes the function Function1( ), to perform a desired procedure, for example accessing a camera device driver. The Function1( ) method includes a call to the SetActive( ) method defined in the CActive class 43. The call to SetActive( ) registers the myAO active object with the active scheduler 25 as active and requiring a response. The call to SetActive( ) will in turn call the RunL( ) method, once the request is complete.

The Client class 42 implements the virtual method RunL( ) defined as a virtual method in the CActive class 43. This contains code for deciding if the method is being called for the first time, which is implemented, for example, by a state machine. The three lines of code following the comment line are only executed if this is the first time that the RunL( ) method has been called.

In an alternative embodiment, a timer object is created and run on start-up to run the RunL( ) method for the first time. On completion, the object sets a flag to indicate that the RunL( ) method has been run.

The code ‘myScheduler->Stop( )’ stops the current active scheduler.

The code ‘myThread->Create( . . . ,(Tint(*)(TAny*))ASThread, . . . , this, . . . ) creates a thread and the code ‘myThread->Resume( )’ starts the thread. ‘ASThread’ is the name of the thread function to which control passes when the thread is resumed. The argument ‘(TInt(*)(TAny*))ASThread’ is a function pointer to the ASThread( ) function declared in accordance with the specification of the Create function in the RThread class of the Symbian™ OS. The ‘this’ pointer, a pointer to the current object of the Client class, in this case myAO, is passed to the ASThread( ) function.

The code fragment ‘( . . . )’ represents any other processing that is required for the method Function1, including callbacks to Java.

The final method in the Client class is the ASThread method, called from the RunL( ) method.

Code fragment ‘((Client*)ptr)->myScheduler->Replace(myScheduler)’ calls the Replace method defined in the CActiveScheduler class of the Symbian™ OS, which allows the current active scheduler to be replaced, while retaining its active objects. The Replace call is not strictly necessary and can be omitted in this particular embodiment, but it is safer to include it, as the ASThread function is not necessarily a member of the Client class.

The code ‘myScheduler->Start( )’ then restarts the active scheduler, which blocks again, but this time the scheduler is running in a separate thread, so that control goes back to the javaClass application 40.

This invention applies to the programming of any device that runs the Symbian™ OS. Java™ is very popular for application development due to its portability and any Java™ application running on these devices and making use of active objects could make use of the invention.

Examples include Java™ multiplayer games using Bluetooth™ and Java™ applications using the phone camera 2.

In addition, it will also be apparent that the implementation of the invention is not limited to the Symbian™ and Java™ platforms, but is applicable to any operating system, language or platform offering similar functionality or suffering from the same problem. It will further be understood that the term ‘active objects’ is not limited to the objects found under the Symbian™ OS, but can be any objects under any operating system that implement similar multi-tasking behaviour under the control of a scheduler or analogous control mechanism.

Although the invention is described in relation to one specific embodiment, it will be appreciated that this is for the purpose of illustration only and that the invention is more broadly applicable. Numerous variations within the scope of the invention will be conceivable by the skilled person.

1. A method of providing access from a first computing platform to active objects on a second computing platform, the method comprising:
receiving a function call from an application on the first computing platform;
in response to the function call, starting an active scheduler in a first thread of control on the second computing platform, the active scheduler being arranged to service requests from the active objects;
creating a second thread of control on the second computing platform; and
transferring the active scheduler into the second thread to enable control to return to the calling application.

2. A method according to claim 1, wherein the active scheduler is transferred in response to a request from an active object.

3. A method according to claim 2, wherein the active object is a timer object started for the purpose of transferring the active scheduler.

4. A method according to claim 2, including the step of determining whether the request from the active object is the first request in a plurality of requests.

5. A method according to claim 4, comprising transferring the active scheduler into the second thread only if the request is the first request.

6. A method according to claim 4, comprising using a state machine to determine if the request is the first request.

7. A method according to claim 1, wherein the step of transferring the active scheduler comprises stopping the active scheduler in the first thread and restarting it in the second thread.

8. A method according to claim 1, wherein the active object comprises an object running in its own thread of control.

9. A system for providing access from a first computing platform to active objects on a second computing platform, the system comprising:
means for receiving a function call from an application on the first computing platform;
means responsive to the function call, for starting an active scheduler in a first thread of control on the second computing platform, the active scheduler being arranged to service requests from the active objects;
means for creating a second thread of control on the second computing platform; and
means for transferring the active scheduler into the second thread to enable control to return to the calling application.

10. A system according to claim 9, wherein the transferring means is configured to transfer the scheduler in response to a request from an active object.

11. A system according to claim 9, wherein the transferring means is configured to transfer the scheduler in response to a request from a timer object started for the purpose of transferring the active scheduler.

12. A system according to claim 9, wherein the transferring means comprises means for stopping the active scheduler in the first thread and means for restarting it in the second thread.

13. A system according to claim 9, including means for determining whether the request from the active object is the first request in a plurality of requests.

14. A system according to claim 13, wherein the transferring means is configured to transfer the active scheduler into the second thread only if the request is the first request.

15. A system according to claim 13, further comprising a state machine for determining if the request is the first request.

16. A system according to claim 9, wherein the first computing platform comprises a Java™ platform and the second computing platform comprises a Symbian™ operating system.

17. A system according to claim 16, wherein the application comprises a Java™ application that accesses the Symbian™ operating system via a Java™ Native Interface JNI.

18. A smartphone comprising a system according to claim 9.

19. A computer program for providing access from a first computing platform to active objects on a second computing platform which, when executed on a computer, is configured to:
receive a function call from an application on a first computing platform;
in response to the function call, start an active scheduler in a first thread of control on a second computing platform, the active scheduler being arranged to service requests from the active objects;
create a second thread of control on the second computing platform; and
transfer the active scheduler into the second thread to enable control to return to the calling application.
